(19) United States
(12) Patent Application Publication
(10) Pub. No.: US 2021/0198844 A1
(43) Pub. Date: Jul. 1, 2021

(54) SUSTAINABLE COMPOSITION AND PROCESS FOR PRODUCTION OF STAIN REPELLENT TEXTILE ARTICLE

(71) Applicants: ROHIT KUMAR GUPTA, Bengaluru (IN); SUBHRA NEEL SAIKIA, Bengaluru (IN)

(72) Inventors: ROHIT KUMAR GUPTA, Bengaluru (IN); SUBHRA NEEL SAIKIA, Bengaluru (IN)

(21) Appl. No.: 16/061,709

(22) PCT Filed: Mar. 15, 2018
(86) PCT No.: PCT/IN2018/050142

§ 371 Date: Jun. 13, 2018

(30) Foreign Application Priority Data
Jul. 28, 2017 (IN) 201741003222

(51) Int. Cl. D06M 23/08; D06M 11/83; D06M 13/00; D06M 13/144; D06M 13/395; D06M 13/517; D06M 15/09; D06M 15/263; D06M 15/31; D06M 15/333; D06M 15/657; D06M 23/12

(52) U.S. Cl. CPC D06M 23/08; D06M 11/83; D06M 13/005; D06M 13/144; D06M 13/395; D06M 13/517; B82Y 30/00; D06M 15/263; D06M 15/31; D06M 15/333; D06M 15/657; D06M 23/12; D06M 15/09

(57) ABSTRACT

The present invention provides a sustainable stain resistant composition 102 that includes (a) about 3% to 8% of at least one silicon nano particle surface functionalized with (Pentafluorophenyl)triethoxysilane 104, and (b) about 3% to 8% of at least one hydrophobic agent 106 selected from a group comprising polymer of (a) methacrylic esters of aliphatic C1 to C18 alcohols, or (b) vinyl acetate, or (c) acrylonitrile. The stain resistant composition further includes (a) at least one softening agent 110, (b) an extending agent 108, (c) at least one of (i) a wetting agent or (ii) a re-wetting agent 112, and (d) a microencapsulated odour neutralizing agent 114. The present invention also relates to a process for producing stain resistant textile 118 using the sustainable stain resistant composition 102.

### CROSS-REFERENCE TO PRIOR FILED PATENT APPLICATIONS

This application claims priority from PCT Patent Application number PCT/IN2018/050142 filed on Mar. 15, 2018 the complete disclosure of which, in its entirely, is herein incorporated by reference.

### BACKGROUND

### Technical Field

The embodiments herein generally relate to production of stain repellent textile articles, and, more particularly, to a composition and process for production of the stain repellent articles having both sustainability and durability.

### Description of the Related Art

In general, the production of the textile articles (e.g. such as denims, fabrics, t-shirts, clothes, pants and other substrates) it is desirable to improve the properties of the textile articles like stain repellency to obtain stain repellent textile articles. The stain repellent textile articles are highly preferred by consumers as the stain repellent textile articles facilitate cleaning.

In general, an existing composition and process for the production of the stain repellent textile articles imparts or focuses either only on sustainability or durability. The quality of the stain repellent textile article depends on the percentage of both sustainability and durability imparted in the stain repellent textile article. Also achieving high degrees of repellency is generally desirable. The existing composition and process are also not comfortable enough to provide sufficient degree of repellency. The existing composition and process further resist breathability that may decrease the life span of the stain repellent textile articles.

Accordingly, there remains a need for an improved composition and process for production of stain repellent textile articles that are adapted for sustainability, durability and breathability.

### SUMMARY

The main objective of the present invention is to provide a stain resistant composition for producing stain repellent article with both sustainability and durability.

In one embodiment, the present invention relates to a stain resistant composition comprising: a) about 3% to 8% of at least one silicon nano particle surface functionalized with fluoro polymer, wherein the fluoro polymer is (Pentafluorophenyl)triethoxysilane, and (b) about 3% to 8% of at least one hydrophobic agent selected from a group comprising polymer of (a) methacrylic esters of aliphatic C1 to C18 alcohols, or (b) vinyl acetate, or (c) acrylonitrile.

In further embodiment, the stain resistant composition also comprises: (a) about 0.2% to 0.5% of at least one softening agent, wherein the at least one softening agent is selected from a group comprising of (a) organic modified polysiloxane or (b) quaternized hydroxyethylcellulose, (b) about 1% to 1.5% of an extending agent, wherein the extending agent includes an aqueous emulsion of blocked polyisocyanate, (c) about 0.1% to 0.3% of at least one of (i) a wetting agent or (ii) a re-wetting agent, wherein the wetting agent or re-wetting agent includes Isopropyl alcohol, and (d) 0.5% to 1% of a microencapsulated odour neutralizing agent, wherein the microencapsulated odor neutralizing agent includes metallic silver micro particles.

In another embodiment, the present invention relates to a process of preparing a stain repellent textile article with sustainability, breathability and durability, comprising: (a) padding a textile article at 1.5 to 2 bar pressure with a stain resistant composition in a room temperature, wherein the stain resistant composition comprises (i) 3% of at least one silicon nano particle surface functionalized with (Pentafluorophenyl)triethoxysilane, and (ii) 6% of at least one hydrophobic agent selected from a group consisting polymer of (a) methacrylic esters of aliphatic C1 to C18 alcohols, or (b) vinyl acetate, or (c) acrylonitrile, (b) squeezing the textile article obtained from step (i) to remove excessive amount of the stain resistant composition from the textile article using squeeze rollers; (c) drying the stain resistant textile article obtained from step (ii) at a temperature ranges from 110° C. to 150° C. for 1 minute to fix the stain resistant composition on the textile article, and (d) curing the textile article obtained from step (iii) at 175° C. temperature for 5 to 6 minutes to obtain the stain resistant composition coated textile article.

In an embodiment, the textile article is a fabric article.

In yet another embodiment, the present invention relates to a process of preparing a stain repellent garment textile article with sustainability, breathability and durability, comprising: (a) dipping the garment textile article in a chemical bath for a predefined time period comprising (i) 3% to 8% of at least one silicon nano particle surface functionalized with (Pentafluorophenyl)triethoxysilane, and (ii) 3% to 8% of at least one hydrophobic agent selected from a group consisting polymer of (a) methacrylic esters of aliphatic C1 to C18 alcohols, or (b) vinyl acetate, or (c) acrylonitrile (b) hydro extracting the excess chemical from the garment textile article obtained from step (i), (c) tumble drying the stain resistant garment textile article obtained from step (ii) at 100° C. for a second predefined time period, and (d) loading the stain resistant garment textile article obtained from step (iii) into a chlorine chamber for the predefined time period.

In further embodiment, the stain resistant composition used for producing textile article with sustainability, breathability and durability also comprises: (a) about 0.2% to 0.5% of at least one softening agent, wherein the at least one softening agent is selected from a group comprising of (a) organic modified polysiloxane or (b) quaternized hydroxyethylcellulose, (b) about 1% to 1.5% of an extending agent, wherein the extending agent includes an aqueous emulsion of blocked polyisocyanate, (c) about 0.1% to 0.3% of at least one of (i) a wetting agent or (ii) a re-wetting agent, wherein the wetting agent or re-wetting agent includes Isopropyl alcohol, and (d) 0.5% to 1% of a microencapsulated odour neutralizing agent, wherein the microencapsulated odor neutralizing agent includes metallic silver micro particles.

In another embodiment, stain resistant composition in a chemical bath having Material Liquor Ratio (MLR) of 1:1 to 1:1.5.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a flow diagram that illustrates a sustainable composition and a stain repellent textile article produced using the sustainable composition according to an embodiment herein;

FIG. 2 illustrates a process of production of the stain repellent textile article in a fabric stage according to an embodiment herein;

FIG. 3 is a flow diagram that illustrates a method of production of the stain repellent textile article in the fabric stage according to an embodiment herein; and

FIG. 4 is a flow diagram that illustrates a method of production of the stain repellent textile article in a garment stage according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

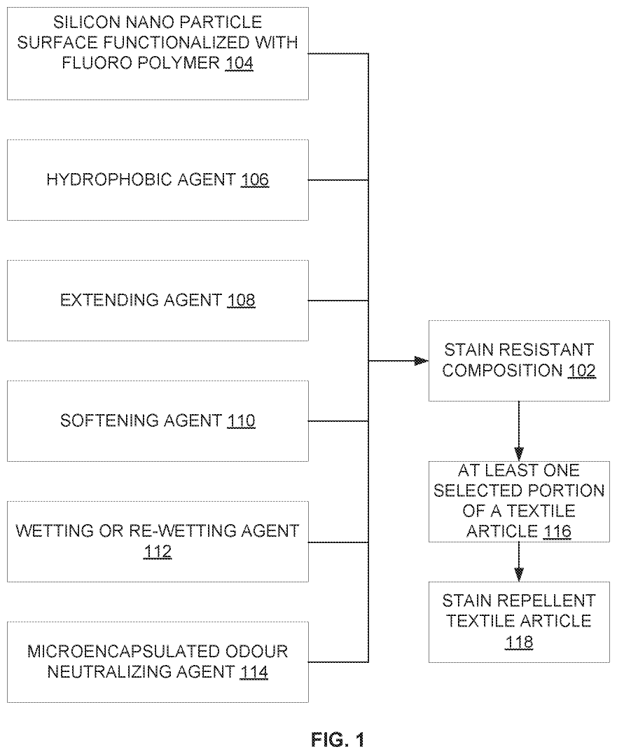

As mentioned, there remains a need for an improved composition and process for production of stain repellent textile article that are adapted for sustainability, durability and breathability. The embodiments herein achieve this by providing a sustainable composition and a process for the production of stain repellent textile article that are applicable for both fabric stage and garment stage of the textile article. Referring now to the drawings, and more particularly to FIGS. 1 through 4, where similar reference characters denote corresponding features consistently throughout the figures, preferred embodiments are shown.

FIG. 1 is a flow diagram that illustrates a sustainable composition 102 and a stain repellent textile article 118 produced using the sustainable composition 102 according to an embodiment herein.

Accordingly, the present sustainable composition 102 for the production of the stain repellent textile article 118 is made up from at least one silicon nano particle surface functionalized with fluoro polymer 104 and at least one hydrophobic agent 106. The at least one silicon nano particle surface functionalized with fluoro polymer 102 is present in 3 to 8 weight percent and the at least one hydrophobic agent 104 is present in 3 to 8 weight percent of the sustainable composition 102. The at least one silicon nano particle surface functionalized with fluoro polymer 104 is silicon nano particle surface functionalized with (Pentafluorophenyl)triethoxysilane. The at least one hydrophobic agent 106 is selected from a group comprising polymer of (a) methacrylic esters of aliphatic C1 to C18 alcohols, or (b) vinyl acetate, or (c) acrylonitrile.

The stain resistant composition 102 also including, (a) about 0.2% to 0.5% of at least one softening agent, wherein the at least one softening agent 110 is selected from a group including of (a) organic modified polysiloxane or (b) quaternized hydroxyethyl cellulose, (b) about 1% to 1.5% of an extending agent 108, wherein the extending agent includes an aqueous emulsion of blocked polyisocyanate, (c) about 0.1% to 0.3% of at least one of (i) a wetting agent or (ii) a re-wetting agent 112. In one embodiment, the wetting agent or re-wetting agent includes Isopropyl alcohol, and (d) 0.5% to 1% of a microencapsulated odour neutralizing agent 114, wherein the microencapsulated odor neutralizing agent includes metallic silver micro particles.

In an embodiment, at least one hydrophobic agent 106 of the sustainable stain resistant composition 102 selected from a group comprising polymer of (a) methacrylic esters of aliphatic C1 to C18 alcohols, or (b) vinyl acetate, or (c) acrylonitrile. The Examples of such polymers that are commercially available and used in the present invention is PUREPEL FF (RESIL), PRIMAL 644 (Rohm & Haas).

In another embodiment, softening agent 110 of the sustainable stain resistant composition 102 is selected from a group comprising of (a) organic modified polysiloxane or (b) quaternized hydroxyethylcellulose which is available under PUREPEL SOFT (RESIL), quaternized hydroxyethylcellulose available under Polymer JR 400 from Amerchol.

The sustainable composition 102 is processed to the at least one selected portion of the textile article 116 in a chemical bath. The at least one selected portion of the textile article 116 includes a plurality of pores. The plurality of pores of at least one selected portion of the textile article 116 having a basic surface tension. The at least one selected portion of the textile article 116 may be selected by a cross linking structure connected to the textile article 116. The stain resistant composition 102 prevents at least one liquid from passing through the plurality of pores by altering the basic surface tension of the textile article, when the at least one liquid pours/passes over the textile article accidentally.

The stain resistant composition 102 may function as a blocking composition that not only preventing the at least one liquid from passing through the plurality of pores, but considerably permitting at least one vapour to pass through the plurality of pores to maintain or enable breathability of the at least one selected portion of the textile article.

The softening agent 110 used in the present sustainable composition 102 provides at least one of (i) softness, (ii) better handling, (iii) drape, (iv) cutting and (v) sewing qualities to the at least one selected portion of the textile article. The softening agent 110 further improves the aesthetic properties of the at least one selected portion of the textile article. The microencapsulated odour neutralizing agent 114 decreases at least one odour evolved from body sweat of a consumer wearing the stain repellent textile article.

The extending agent 108 used in the present sustainable composition 102 increases the area covered by a given weight of composition.

The sustainable composition 102 includes at least one of (i) a wetting agent and/or (ii) a non-rewetting agent 112 that reduces the basic surface tension of the textile article and make the sustainable composition 102 more effective in spreading over and penetrating through the at least one selected portion of the textile article 116.

The sustainable composition 102 and the process are applicable for the production of at least one of (i) a fabric stage and (ii) a garment stage of the stain repellent textile article. The sustainable composition and the process are also applicable for at least one of (i) an automated production of the stain repellent textile article and (ii) manual production of the stain repellent textile article. The stain repellent textile article may be denim, a t-shirt, a shirt, a pant and the like. The stain repellent textile article may be cotton, a cotton blend fabric and the like.

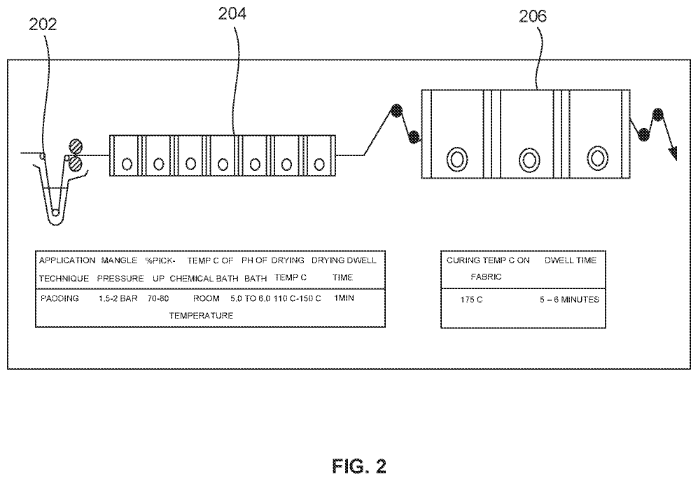

FIG. 2 illustrates a process of production of the stain repellent textile article 118 in a fabric stage according to an embodiment herein. The process includes a padding 202, a drying 204, and a curing 206. The padding 202 is performed after applying the composition 102 to the textile article by setting up a Material Liquid Ratio (MLR) of 1:1 to 1:1.5 in a chemical bath. In one embodiment, the padding process 202 is performed by maintaining (i) 1.5 to 2 bar of mangle pressure, and (ii) 70% to 80% of chemical pickup at room temperature in the chemical bath including the sustainable composition 102 with 5.0 to 6.0 pH. The drying unit 204 includes multiple chambers for drying the textile article. The chamber 1, 2, 3 & 4 of drying unit 204 having temperature of 110° C., 130° C., 150° C. at chamber 1, chamber 2, and chamber 3 and 4 respectively and the drying process is performed for a first predefined time period (e.g. 1 minute) to fix the stain resistant composition on the textile article. The curing 206 is performed by maintaining 175° C. of curing temperature for a second predefined time period (e.g. 5 to 6 minutes) to obtain the stain resistant composition coated textile article 118.

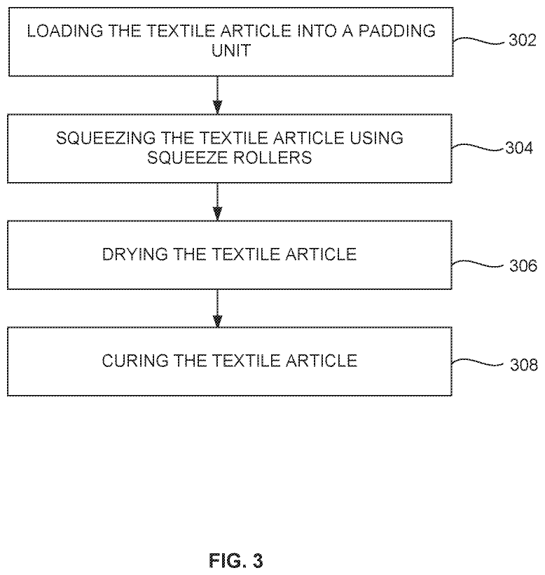

FIG. 3 is a flow diagram that illustrates a method of production of the stain repellent textile article in the fabric stage according to an embodiment herein. At step 302, a textile article is loaded into a padding unit comprising the sustainable stain resistant composition 102 of the present invention. The material liquid ratio (MLR) of the sustainable composition 102 in the padding unit in ratio of 1:1 to 1:1.5. At step 304, the textile article obtained from step 302 is squeezed to remove excessive amount of the stain resistant composition 102 from the textile article using squeeze rollers. At step 306, the stain resistant textile article 118 obtained from step 304 is dried at a temperature ranges from 110° C. to 150° C. for 1 minute to fix the stain resistant composition 102 on the textile article. At step 308, the textile article obtained from step 306 is cured at 175° C. temperature for 5 to 6 minutes to obtain the stain resistant composition coated textile article 118. In one embodiment, the padding unit is a foulard system. In yet another embodiment, the sustainable composition 102 is applied evenly by padding the textile article in the chemical bath. In yet another embodiment, the textile article is heated to evenly spread the sustainable composition 102 on the textile article. The method further includes conventional steps for processing the fabric of the textile article according to an end product required. In an embodiment, the sustainable stain resistant composition 102 comprising 3% of at least one silicon nano particle surface functionalized with (Pentafluorophenyl)triethoxysilane 104, and (ii) 6% of at least one hydrophobic agent 106 selected from a group consisting polymer of (a) methacrylic esters of aliphatic C1 to C18 alcohols, or (b) vinyl acetate, or (c) acrylonitrile.

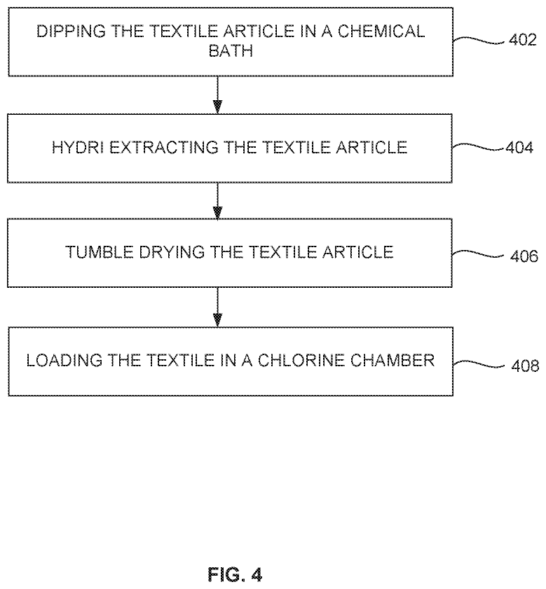

FIG. 4 is a flow diagram that illustrates a method of production of the stain repellent textile article 102 in the garment stage according to an embodiment herein. At step 402, a textile article is dipped into a saturator unit comprising the sustainable composition 102 of the present invention for 20 minutes. At step 404, the garment textile article obtained from step 402 is hydro extracted to remove the excess chemical from the garment textile article. At step 406, the stain resistant garment textile article 118 obtained from step 404 is tumble dried at 100° C. for 40 minutes. In one embodiment, the material liquid ratio (MLR) of the sustainable composition in the saturator unit in ratio of 1:1 to 1:1.5. In another embodiment, the sustainable composition 102 comprising i) 3% to 8% of at least one silicon nano particle surface functionalized with (Pentafluorophenyl)triethoxysilane 104, and (ii) 3% to 8% of at least one hydrophobic agent 106 selected from a group consisting polymer of (a) methacrylic esters of aliphatic C1 to C18 alcohols, or (b) vinyl acetate, or (c) acrylonitrile.

The sustainable composition and the process is not limited to only applicable for cotton and cotton blend fabrics but also for other materials like polyster, nylon and the like. The sustainable composition and the process are utilized in automated production of stain repellent textile article both in the fabric stage and the garment stage (i.e. end product). The sustainable composition and process (i) improves aesthetic properties of the stain repellent textile article, (ii) facilitates cleaning of the stain repellent textile article, and (ii) improves the lifespan of the stain repellent textile article.

A more comprehensive understanding of the invention can be obtained by considering the following examples. However, it should be understood that the examples are not intended to be unduly limitative of the invention.

The Examples 1A-7A represents the composition of surface modified silicon nanoparticles with fluoro polymer and hydrophobic agent.

Example 1A: The composition 1A comprising 3% of silicon nano particle surface functionalized with (Pentafluorophenyl)triethoxysilane, 3% of hydrophobic agent such as PUREPEL FF, 0.5% of Softener such as PUREPEL SOFT, and 1.5% of extending agent is prepared using suitable chemical process. The remaining portion of the composition includes water. The composition 1A is loaded into a saturator unit with material to liquid ratio of 1:1-1:1.5. The 1.5 Kg of 100% cotton fabric is dipped in the bath solution for 20 minutes, then hydroextracted the extra solution absorbed from the fabric. The treated fabric is tumble dried at 80-90° C. for 20 minutes and then cured at 150° C. temperature in an oven to obtain the stain resistant textile article.

Example 2A: The composition 2A comprising 4% of silicon nano particle surface functionalized with (Pentafluorophenyl)triethoxysilane, 3% of hydrophobic agent such as PUREPEL FF, 0.5% of Softener such as PUREPEL SOFT, and 1.5% of extending agent is prepared using suitable chemical process. The remaining portion of the composition includes water. The composition 2A is loaded into a saturator unit with material to liquid ratio of 1:1-1:1.5. The 1.5 Kg of 100% cotton fabric is dipped in the bath solution for 20 minutes, then hydroextracted the extra solution absorbed from the fabric. The treated fabric is tumble dried at 80-90° C. for 20 minutes and then cured at 150° C. temperature in an oven to obtain the stain resistant textile article.

Example 3A: The composition 3A comprising 5% of silicon nano particle surface functionalized with (Pentafluorophenyl)triethoxysilane, 3% of hydrophobic agent such as PUREPEL FF, 0.5% of Softener such as PUREPEL SOFT, and 1.5% of extending agent is prepared using suitable chemical process. The remaining portion of the composition includes water. The composition 3A is loaded into a saturator unit with material to liquid ratio of 1:1-1:1.5. The 1.5 Kg of 100% cotton fabric is dipped in the bath solution for 20 minutes, then hydroextracted the extra solution absorbed from the fabric. The treated fabric is tumble dried at 80-90° C. for 20 minutes and then cured at 150° C. temperature in an oven to obtain the stain resistant textile article.

Example 4A: The composition 4A comprising 6% of silicon nano particle surface functionalized with (Pentafluorophenyl)triethoxysilane, 3% of hydrophobic agent such as PUREPEL FF, 0.5% of Softener such as PUREPEL SOFT, and 1.5% of extending agent is prepared using suitable chemical process. The remaining portion of the composition includes water. The composition 4A is loaded into a saturator unit with material to liquid ratio of 1:1-1:1.5. The 1.5 Kg of 100% cotton fabric is dipped in the bath solution for 20 minutes, then hydroextracted the extra solution absorbed from the fabric. The treated fabric is tumble dried at 80-90° C. for 20 minutes and then cured at 150° C. temperature in an oven to obtain the stain resistant textile article.

Example 5A: The composition 5A comprising 3% of silicon nano particle surface functionalized with (Pentafluorophenyl)triethoxysilane, 4% of hydrophobic agent such as PUREPEL FF, 0.5% of Softener such as PUREPEL SOFT, and 1.5% of extending agent is prepared using suitable chemical process. The remaining portion of the composition includes water. The composition 5A is loaded into a saturator unit with material to liquid ratio of 1:1-1:1.5. The 1.5 Kg of 100% cotton fabric is dipped in the bath solution for 20 minutes, then hydroextracted the extra solution absorbed from the fabric. The treated fabric is tumble dried at 80-90° C. for 20 minutes and then cured at 150° C. temperature in an oven to obtain the stain resistant textile article.

Example 6A: The composition 6A comprising 3% of silicon nano particle surface functionalized with (Pentafluorophenyl)triethoxysilane, 5% of hydrophobic agent such as PUREPEL FF, 0.5% of Softener such as PUREPEL SOFT, and 1.5% of extending agent is prepared using suitable chemical process. The remaining portion of the composition includes water. The composition 6A is loaded into a saturator unit with material to liquid ratio of 1:1-1:1.5. The 1.5 Kg of 100% cotton fabric is dipped in the bath solution for 20 minutes, then hydroextracted the extra solution absorbed from the fabric. The treated fabric is tumble dried at 80-90° C. for 20 minutes and then cured at 150° C. temperature in an oven to obtain the stain resistant textile article.

Example 7A: The composition 7A comprising 3% of silicon nano particle surface functionalized with (Pentafluorophenyl)triethoxysilane, 6% of hydrophobic agent such as PUREPEL FF, 0.5% of Softener such as PUREPEL SOFT, and 1.5% of extending agent is prepared using suitable chemical process. The remaining portion of the composition includes water. The composition 7A is loaded into a saturator unit with material to liquid ratio of 1:1-1:1.5. The 1.5 Kg of 100% cotton fabric is dipped in the bath solution for 20 minutes, then hydroextracted the extra solution absorbed from the fabric. The treated fabric is tumble dried at 80-90° C. for 20 minutes and then cured at 150° C. temperature in an oven to obtain the stain resistant textile article.

The stain resistant textile article produced through Example 1A to 7A is evaluated by contact angle measurement test, stain test, abrasion test, and durability test. The test results are shown in below tables.

Table 1 shows contact angle measurement test results before washing the textile article using goniometer. The contact angle measurement is used to determine the contact angle of both water and oil on fabric.

TABLE 1

| Contact Angle (In degree) | 1A | 2A | 3A | 4A | 5A | 6A | 7A |
|---|---|---|---|---|---|---|---|
| Water/oil | 80/55 | 90/70 | 100/80 | 110/90 | 90/60 | 110/80 | 115/90 |
| Water/oil | 75/50 | 85/65 | 95/75 | 105/85 | 80/55 | 100/70 | 110/85 |
| (after 10 mins) | | | | | | | |

Table 2 shows stain test results. Variety of daily stains are applied on treated and untreated fabric to determine the easy stain removal and rated as 1—Much worse than untreated, 2—Worse than untreated, 3—Equal to untreated, 4—Better than untreated, 5—Much better than untreated.

TABLE 2

| Stain Type | Untreated | 1A | 2A | 3A | 4A | 5A | 6A | 7A |
|---|---|---|---|---|---|---|---|---|
| Coffee | Ref | 4 | 5 | 5 | 5 | 4 | 5 | 5 |
| Tea | Ref | 4 | 5 | 5 | 5 | 4 | 5 | 5 |
| Ketchup | Ref | 4 | 5 | 5 | 5 | 4 | 5 | 5 |
| Curry | Ref | 4 | 5 | 5 | 5 | 4 | 5 | 5 |

Table 3 shows the abrasion test results and is performed using the Martindale method. A load pressure of 12 kPa is employed, which is typically used for evaluating heavy duty upholstery usages.

TABLE 3

| | Abrasion Cycles | | | | | | |
|---|---|---|---|---|---|---|---|
| | (water/hexadecane/soyabean oil) | | | | | | |
| | 1A | 2A | 3A | 4A | 5A | 6A | 7A |
| 5000 | 80/50/50 | 90/65/65 | 100/80/80 | 110/90/90 | 90/55/55 | 110/75/75 | 115/85/85 |
| 8000 | 80/50/50 | 90/60/60 | 100/75/75 | 110/90/90 | 90/55/55 | 110/75/75 | 115/85/85 |
| 10000 | 70/45/45 | 80/50/50 | 90/70/70 | 110/85/85 | 80/45/45 | 100/65/65 | 105/75/75 |
| 15000 | 60/40/40 | 70/45/45 | 80/60/60 | 110/80/80 | 70/40/40 | 90/60/60 | 95/70/70 |

Table 4 shows the durability test results. Durability test is conducted for the fabric to evaluate the durability of the finished article after multiple wash cycles. AATCC Test method 118 (American Association of Textile Chemist and Colorist) is used to perform this test. In this, fabric is machine washed at 8000 rpm at 40° C. using TIDE (P&G company) commercial detergent. After washing, the fabric is dried in dryer for 40 minutess at 80-90° C.

TABLE 4

| Wash Cycle (HL) | 1A | 2A | 3A | 4A | 5A | 6A | 7A |
|---|---|---|---|---|---|---|---|
| 5 | 100 | 100 | 100 | 100 | 100 | 100 | 100 |
| 10 | 80 | 80 | 85 | 85 | 85 | 85 | 90 |
| 15 | 75 | 75 | 80 | 80 | 80 | 80 | 90 |
| 20 | 70 | 70 | 75 | 75 | 75 | 75 | 80 |
| 25 | 65 | 65 | 70 | 70 | 70 | 70 | 80 |
| 30 | 60 | 60 | 65 | 65 | 65 | 65 | 75 |

Table 5 shows stain test results after 30 wash cycle (HL) to determine the easy stain removal and rated as 1—Much worse than untreated, 2—Worse than untreated, 3—Equal to untreated, 4—Better than untreated, 5—Much better than untreated.

TABLE 5

| Stain Type | Untreated | 1A | 2A | 3A | 4A | 5A | 6A | 7A |
|---|---|---|---|---|---|---|---|---|
| Coffee | Ref | 4 | 5 | 5 | 5 | 4 | 5 | 5 |
| Tea | Ref | 4 | 5 | 5 | 5 | 4 | 5 | 5 |
| Ketchup | Ref | 4 | 5 | 5 | 5 | 4 | 5 | 5 |
| Curry | Ref | 4 | 5 | 5 | 5 | 4 | 5 | 5 |

Example 1B to 5B is performed by varying the curing temperature while producing the stain resistant textile article using composition prepared in example 1B to 5B.

Example 1B: The composition 1B comprising 6% of silicon nano particle surface functionalized with (Pentafluorophenyl)triethoxysilane, 6% of hydrophobic agent such as PUREPEL FF, 0.5% of Softener such as PUREPEL SOFT, and 1.5% of extending agent is prepared using suitable chemical process. The remaining portion of the composition includes water. The composition 1B is loaded into a saturator unit in a material to liquid ratio of 1:1-1:1.5. The 1.5 KG of 100% cotton fabric is dipped in the bath solution for 20 minutes, then hydroextracted the extra solution absorbed from the fabric. The treated fabric is tumble dried at 80-90° C. for 20 minutes and then cured in an oven at 110° C. temperature to obtain the stain resistant textile article

Example 2B: The composition 2B comprising 6% of silicon nano particle surface functionalized with (Pentafluorophenyl)triethoxysilane, 6% of hydrophobic agent such as PUREPEL FF, 0.5% of Softener such as PUREPEL SOFT, and 1.5% of extending agent is prepared using suitable chemical process. The remaining portion of the composition includes water. The composition 2B is loaded into a saturator unit with material to liquid ratio of 1:1-1:1.5. The 1.5 KG of 100% cotton fabric is dipped in the bath solution for 20 minutes, then hydroextracted the extra solution absorbed from the fabric. The treated fabric is tumble dried at 80-90° C. for 20 minutes and then cured in an oven at 120° C. temperature to obtain the stain resistant textile article.

Example 3B: The composition 3B comprising 6% of silicon nano particle surface functionalized with (Pentafluorophenyl)triethoxysilane, 6% of hydrophobic agent such as PUREPEL FF, 0.5% of Softener such as PUREPEL SOFT, and 1.5% of extending agent is prepared using suitable chemical process. The remaining portion of the composition includes water. The composition 3B is loaded into a saturator unit with material to liquid ratio of 1:1-1:1.5. The 1.5 KG of 100% cotton fabric is dipped in the bath solution for 20 minutes, then hydroextracted the extra solution absorbed from the fabric. The treated fabric is tumble dried at 80-90° C. for 20 minutes and then cured in an oven at 130° C. temperature to obtain the stain resistant textile article

Example 4B: The composition 4B comprising 6% of silicon nano particle surface functionalized with (Pentafluorophenyl)triethoxysilane, 6% of hydrophobic agent such as PUREPEL FF, 0.5% of Softener such as PUREPEL SOFT, and 1.5% of extending agent is prepared using suitable chemical process. The remaining portion of the composition includes water. The composition 4B is loaded into a saturator unit with material to liquid ratio of 1:1-1:1.5. The 1.5 KG of 100% cotton fabric is dipped in the bath solution for 20 minutes, then hydroextracted the extra solution absorbed from the fabric. The treated fabric is tumble dried at 80-90° C. for 20 minutes and then cured in an oven at 140° C. temperature to obtain the stain resistant textile article.

Example 5B: The composition 5B comprising 6% of silicon nano particle surface functionalized with (Pentafluorophenyl)triethoxysilane, 6% of hydrophobic agent such as PUREPEL FF, 0.5% of Softener such as PUREPEL SOFT, and 1.5% of extending agent is prepared using suitable chemical process. The remaining portion of the composition includes water. The composition 5B is loaded into a saturator unit in a material to liquid ratio of 1:1-1:1.5. The 1.5 KG of 100% cotton fabric is dipped in the bath solution for 20 minutes, then hydroextracted the extra solution absorbed from the fabric. The treated fabric is tumble dried at 80-90° C. for 20 minutes and then cured in an oven at 150° C. temperature to obtain the stain resistant textile article.

The stain resistant textile article produced through Example 1B to 5B is evaluated by contact angle measurement test, and durability test. The test results are shown in below tables.

Table 8 shows contact angle measurement test results before washing the textile article using goniometer. The contact angle measurement is used to determine the contact angle of both water and oil on fabric

TABLE 8

| Contact Angle (In degree) | 1A | 2A | 3A | 4A | 5A |
|---|---|---|---|---|---|
| Water/oil | 90/60 | 90/60 | 100/70 | 105/75 | 115/90 |
| Water/oil | 80/55 | 80/55 | 90/60 | 95/65 | 110/85 |
| (after 10 mins) | | | | | |

Table 9 shows the durability test result. Durability test is conducted for the fabric to evaluate the durability of the finish after multiple wash cycles. AATCC Test method 118 (American Association of Textile Chemist and Colorist) is used to perform this test. In this, fabric is machine washed at 8000 rpm at 40° C. using TIDE (P&G company) commercial detergent. After washing, the fabric is dried in dryer for 40 minutess at 80-90° C.

TABLE 9

| Wash Cycle (HL) | 1A | 2A | 3A | 4A | 5A |
|---|---|---|---|---|---|
| 5 | 100 | 100 | 100 | 100 | 100 |
| 10 | 80 | 80 | 85 | 90 | 95 |
| 15 | 75 | 75 | 80 | 85 | 90 |
| 20 | 70 | 70 | 75 | 80 | 85 |
| 25 | 65 | 65 | 70 | 75 | 80 |
| 30 | 60 | 60 | 65 | 70 | 75 |

REACH test is performed on stain resistant textile article produced using the present inventive composition. The REACH test is the global accepted test for detecting harmful/ban chemicals in the textile article. The REACH test is performed at TUV Rheinland for the presence of Dimethyl Fumarate, Dimethyl Formamide, Flame Retardants, PFOS/PFOA. White color knitted T-shirt (approximately 180 grams) coated with stain resistant composition includes 3% of silicon nano particle surface functionalized with (Pentafluorophenyl)triethoxysilane, 6% of hydrophobic agent such as PUREPEL FF is taken for REACH test. The Tests results are given in below table.

Table 10 shows test result of Dimethyl Fumarate, Dimethyl Formamide in the sample.

| | | | Machine | |
|---|---|---|---|---|
| | Test | Results | detection | |
| Sample | Parameter | (mg/kg) | limit | Test method |
| Sample 001 | Dimethy | Not detected | 0.05 | In house -solvent |
| (Black print | fumarate | | mg/kg | extraction and |
| with base) | (DMFu) | | | detection by GC-MS |
| Sample 001 | Dimethy | Not detected | 0.05 | In house -solvent |
| (Black print | formamide | | mg/kg | extraction and |
| with base) | (DMFA) | | | detection by GC-MS |

Table 11 shows detection result of flame retardants in the sample.

| | | | Machine | |
|---|---|---|---|---|
| | | Results | detection | |
| Sample | Test Parameter | (%) | limit | Test method |
| Sample 001 | Polybrominated | Not | 5 mg/kg | In house method - |
| (Black print | biphenyls (PBBs) | detected | | Analysis by |
| with base) | (CAS No. 59536- | | | GC-MS) |
| | 65-1) | | | |
| Sample 001 | Tris (2,3- | Not | 5 mg/kg | In house method - |
| (Black print | dibromopropyl) | detected | | Analysis by |
| with base) | phosphate (TRIS) | | | GC-MS) |
| | (CAS No. 126- | | | |
| | 72-7) | | | |
| Sample 001 | Tris (1- | Not | 5 mg/kg | In house method - |
| (Black print | aziridinyl)- | detected | | Analysis by |
| with base) | phosphine oxide | | | GC-MS) |
| | (TEPA) | | | |
| | (CAS No. 545- | | | |
| | 55-1) | | | |
| Sample 001 | Penta- | Not | 5 mg/kg | In house method - |
| (Black print | bromodiphenyl | detected | | Analysis by |
| with base) | ether (penta BDE) | | | GC-MS) |
| | (CAS No. 32534- | | | |
| | 81-9) | | | |

Table 12 shows test of PFOS/PFOA in the sample.

| | | | Machine | |
|---|---|---|---|---|
| | Test | Results | detection | |
| Sample | Parameter | (μg/m2) | limit | Test method |
| Sample 001 | PFOS | Not detected | | Organic solvent |
| (Black print | | | | extraction by |
| with base) | | | | LC-MS-MC |
| Sample 001 | PFOA | Not detected | 1 μg/m² | |
| (Black print | | | | |
| with base) | | | | |

From the above REACH test results, it is found that the stain resistant textile article produced using the sustainable stain resistant composition of the present invention is highly safe and suitable for human use.

The foregoing description of the specific embodiments will so fully reveal the general nature of the embodiments herein that others can, by applying current knowledge, readily modify and/or adapt for various applications such specific embodiments without departing from the generic concept, and therefore such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

I/We claim:

1. A stain resistant composition (102), comprising:
(a) about 3% to 8% of at least one silicon nano particle surface functionalized with fluoro polymer (104), wherein said fluoro polymer is (Pentafluorophenyl)triethoxysilane; and
(b) about 3% to 8% of at least one hydrophobic agent (106) selected from a group comprising polymer of (a) methacrylic esters of aliphatic C1 to C18 alcohols, or (b) vinyl acetate, or (c) acrylonitrile.

2. The stain resistant composition (102) as claimed in claim 1, wherein said stain resistant composition (102) comprises,
(a) about 0.2% to 0.5% of at least one softening agent (110), wherein said at least one softening agent is selected from a group comprising of (a) organic modified polysiloxane or (b) quaternized hydroxyethylcellulose;
(b) about 1% to 1.5% of an extending agent (108), wherein said extending agent includes an aqueous emulsion of blocked polyisocyanate; and
(c) about 0.1% to 0.3% of at least one of (i) a wetting agent or (ii) a re-wetting agent (112), wherein said wetting agent or re-wetting agent includes Isopropyl alcohol.

3. The stain resistant composition (102) as claimed in claim 1, wherein said stain resistant composition (102) comprises 0.5% to 1% of a microencapsulated odour neutralizing agent (114), wherein said microencapsulated odor neutralizing agent includes metallic silver micro particles.

4. A process of preparing a stain repellent textile article (118) with sustainability, breathability and durability, comprising:
(i) padding a textile article at 1.5 to 2 bar pressure with a stain resistant composition, wherein said stain resistant composition (102) comprises (i) 3% of at least one silicon nano particle surface functionalized with (Pentafluorophenyl)triethoxysilane (104), and (ii) 6% of at least one hydrophobic agent (106) selected from a group consisting of (a) methacrylic esters of aliphatic C1 to C18 alcohols, or (b) vinyl acetate, or (c) acrylonitrile,
(ii) squeezing the textile article obtained from step (i) to remove excessive amount of the stain resistant composition (102) from the textile article using squeeze rollers;
(iii) drying the stain repellent textile article (118) obtained from step (ii) at a temperature ranges from 110° C. to 150° C. for 1 minute to fix the stain resistant composition (102) on the textile article; and
(iv) curing the textile article obtained from step (iii) at 175° C. temperature for 5 to 6 minutes to obtain the stain resistant composition coated textile article (118).

5. The process as claimed in claim 4, wherein the textile article is a fabric article.

6. The process as claimed in claim 4, wherein said strain resistant composition (102) comprises (i) 0.2% to 0.5% of at least one softening agent (110) selected from a group comprising of (a) organic modified polysiloxane, or (b) quaternized hydroxyethylcellulose, (ii) 1% to 1.5% of an extending agent (108), wherein said extending agent includes an aqueous emulsion of blocked polyisocyanate, (iii) 1% to 0.3% of at least one of (i) a wetting agent or (ii) a re-wetting agent (112) wherein said wetting agent or re-wetting agent includes Isopropyl alcohol, and (iv) 0.5% to 1% microencapsulated odour neutralizing agent (114), wherein said microencapsulated odor neutralizing agent includes metallic silver micro particles.

7. A process of preparing a stain repellent garment textile (118) article with sustainability, breathability and durability, comprising:
(i) dipping the garment textile article in a chemical bath for a first predefined time period comprising (i) 3% to 8% of at least one silicon nano particle surface functionalized with (Pentafluorophenyl)triethoxysilane (104), and (ii) 3% to 8% of at least one hydrophobic agent (106) selected from a group consisting of (a) methacrylic esters of aliphatic C1 to C18 alcohols, or (b) vinyl acetate, or (c) acrylonitrile;
(ii) hydro extracting the excess chemical from the garment textile article obtained from step (i);
(iii) tumble drying the stain resistant garment textile (118) article obtained from step (ii) at 100° C. for a second predefined time period; and
(iv) loading the stain resistant garment textile article (106) obtained from step (iii) into a chlorine chamber for the first predefined time period.

8. The process as claimed in claim 7, wherein said strain resistant composition (102) comprises (i) 0.2% to 0.5% of at least one softening agent (110) selected from a group comprising of (a) organic modified polysiloxane, or (b) quaternized hydroxyethylcellulose, (ii) 1% to 1.5% of an extending agent (108), wherein said extending agent includes an aqueous emulsion of blocked polyisocyanate, (iii) 1% to 0.3% of at least one of (i) a wetting agent or (ii) a re-wetting agent (112) wherein said wetting agent or re-wetting agent includes Isopropyl alcohol, and (iv) 0.5% to 1% microencapsulated odour neutralizing agent (114), wherein said microencapsulated odor neutralizing agent includes metallic silver micro particles.

9. The process as claimed in claim 8, wherein said stain resistant composition (102) in a chemical bath having Material Liquor Ratio (MLR) of 1:1 to 1:1.5.

10. The process as claimed in claim 7, wherein the process is applied to a portion of the textile article, wherein the portion of the textile article is selected using a cross linking structure, wherein the predefined time period is 20 minutes and the second predefined time period is 40 minutes.
